(19) United States
(12) Patent Application Publication
(10) Pub. No.: US 2006/0105782 A1
(43) Pub. Date: May 18, 2006

(54) Method and apparatus for controlling a geo-tracking device

(76) Inventor: Cameron Brock, Beverly Hills, CA (US)

Correspondence Address: Jack J'maev;Suite H, 187 W. Orangethorpe Ave., Placentia, CA, 92870, US

(21) Appl. No.: 10/988,116

(22) Filed: Nov. 12, 2004

(51) Int. Cl. H04Q 7/20

(52) U.S. Cl. 455/456.2; 455/456.1

(57) ABSTRACT

A method and an embodiment for controlling a geo-tracking device by receiving a request for a geo-location, conveying a wakeup signal to a geo-tracking device according to the request, receiving from the geo-tracking device one or more position messages, generating a position report according to the one or more position messages and conveying the position report to user.

### BACKGROUND

There are now many different ways to track people, animals and various assets. With the introduction of low-cost geo-positioning receivers, very precise geo-location can be accomplished using satellite positioning systems. The Global Positioning System is just one of many different satellite systems that can be used to determine geo-location. One important aspect of these satellite positioning systems is that a geo-position can be determined merely by passive monitoring of the signals emanating from several satellites. Because a geo-positioning receiver does not need to transmit anything up to a constellation of satellites, the geo-positioning receiver can be manufactured as an exceptionally low-powered single-chip apparatus.

Even though a modern geo-positioning receiver is both low-power and low-cost, there are still fundamental problems in using this technology in tracking applications. First, the receiver can not, in and of itself, convey a geo-location back to a tracking facility. In other words, there must be some means of conveying the geo-location of a person, an animal or an asset back to the tracking facility. One solution to this problem is that of combining a cellular telephone circuit with a geo-location receiver. Voilá, a tracking apparatus is born. This type of tracking apparatus is still not the ideal solution to many tracking applications. One reason is that the cellular telephone circuit, in order to interact with a cellular telephone system, ends up consuming quite a bit of power. Although the amount of power that a combination geo-location receiver and cellular telephone circuit does not pose a great problem in some application, it is simply prohibitive in most tracking applications.

The amount of power that a tracking apparatus uses is not a problem when high-value assets need to be tracked. For example, trucks and cargo containers can be equipped with enough battery reserve to run for extended periods of time. When these types of assets are further equipped with a solar-based battery charger, the tracking apparatus can operate indefinitely.

The amount of power that a tracking apparatus uses becomes especially problematic when tracking people or animals. It is burdensome, to say the least, to strap a large battery to a person or to an animal. Even more cumbersome is the need to either recharge or replace the battery on a regular basis. This, though, is required because the cellular telephone circuit that is used to convey a geo-location back to the tracking facility can easily drain a moderately sized battery in a few days.

There has simply been no way to avoid this type of power consumption because the cellular telephone circuit needs to be energized on a continuous basis. This is because the cellular telephone circuit is typically used to request a geo-location from the tracking apparatus. Once the request for geo-location is received by the cellular telephone circuit, the geo-location receiver is commanded to determine its geo-location. The determined geo-location is then conveyed back to the tracking facility using the cellular telephone circuit. There is simply no way to request a geo-location from the tracking apparatus unless the cellular telephone circuit is constantly operating and using electrical power. And, because of the nature of cellular communication systems, the cellular telephone circuit operates in a transmit mode in order to log in with a cellular base station. This only increases the amount of operating power that is required to operate the cellular telephone circuit.

### SUMMARY

A method and an embodiment for controlling a geo-tracking device by receiving a request for a geo-location, conveying a wakeup signal to a geo-tracking device according to the request, receiving from the geo-tracking device one or more position messages, generating a position report according to the one or more position messages and conveying the position report to user.

### BRIEF DESCRIPTION OF THE DRAWINGS

Several alternative embodiments will hereinafter be described in conjunction with the appended drawings and figures, wherein like numerals denote like elements, and in which:

FIG. 1 is a flow diagram depicts one example method for controlling a geo-tracking device;

FIG. 2 is a flow diagram that depicts one alternative example method for receiving a request for a geo-location;

FIG. 3 is a flow diagram that depicts one illustrative method for receiving a request for geo-location by means of a voice channel;

FIG. 4 is a flow diagram that depicts a web-based alternative method for receiving a geo-location request;

FIG. 5 is flow diagram that depicts alternative methods for conveying a wake-up message to a geo-tracking device;

FIG. 6 is a flow diagram that depicts a variation the present method wherein a device status indicator is received from a geo-tracking device;

FIG. 7 is a flow diagram that depicts one example method for receiving a position report from a geo-tracking device;

FIG. 8 is a flow diagram that depicts one example method for generating a position report;

FIG. 9 is a flow diagram that depicts one example method for generating a web-page based position report;

FIG. 10 is a block diagram that depicts one example embodiment of an apparatus for controlling a geo-tracking device;

FIG. 11 is a block diagram that depicts one example embodiment of a request receiver;

FIG. 12 is a block diagram that depicts one alternative embodiment of a request receiver capable of receiving a request over a voice channel;

FIG. 13 is a block that depicts one alternative embodiment of a request receiver capable of receiving a geo-location request by means of a web page;

FIG. 14 is a block that depicts one alternative embodiment of a position message receiver capable of receiving a geo-location position message from a geo-tracking device; and

FIG. 15 is a data flow diagram that depicts the internal operation of several alternative embodiments of a position message receiver.

### DETAILED DESCRIPTION

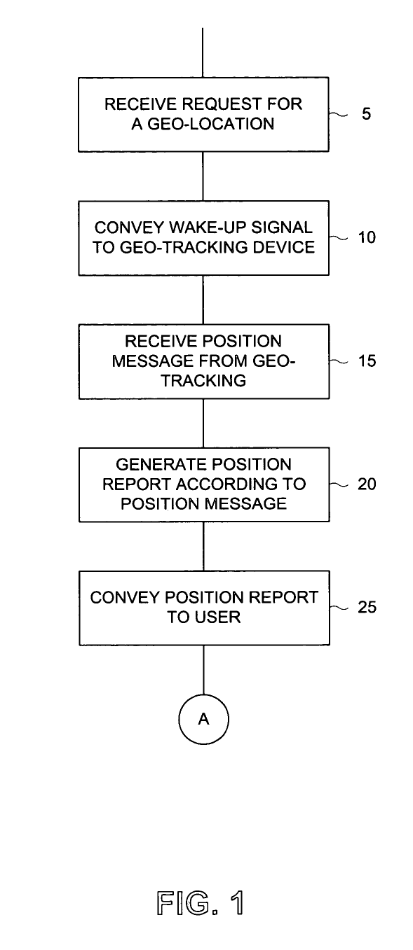

FIG. 1 is a flow diagram depicts one example method for controlling a geo-tracking device. According to this example method, a geo-tracking device is controlled by first receiving a request for a geo-location (step 5). Once a request for a geo-location is received, a wake-up signal is conveyed to the geo-tracking device (step 10). According to this example method, a wake-up signal comprises a unidirectional signal that is conveyed to the geo-tracking device. Accordingly, the geo-tracking device only needs to monitor (i.e. receive) a communications channel in order to receive the unidirectional wake-up signal. It should be appreciated that the geo-tracking device does not need to transmit any information while it is monitoring the communication channel for a wake-up signal. This is in sharp contrast to known art where a cellular telephone circuit must be constantly active (both in receive and transmit modes) in order to interact with a cellular telephone system and to receive a request for a geo-location from a tracking facility. As such, an apparatus that implements the present method can operate at a much lower power and can thus operate for much longer periods of time before a battery needs to be charged or replaced.

According to one variation of the present method, a position message is received from the geo-tracking device (step 15). A position report is then generated according to the position message (step 20). The position report is then conveyed to a user (step 25).

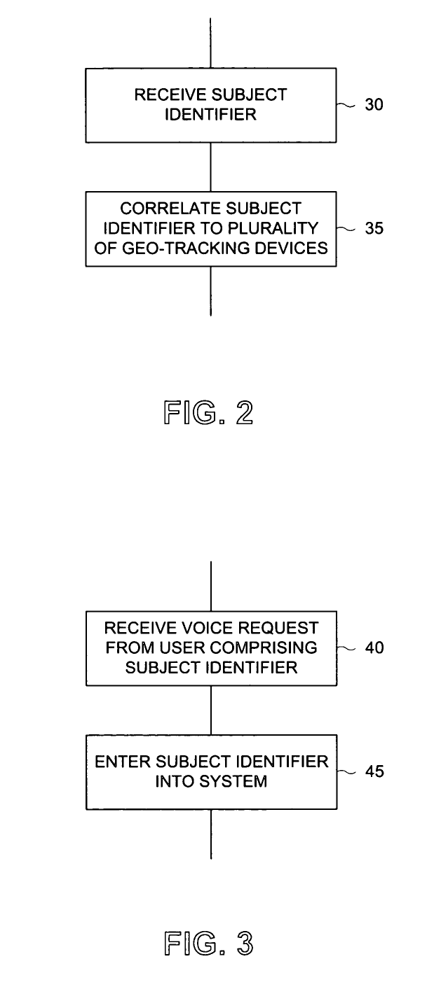

FIG. 2 is a flow diagram that depicts one alternative example method for receiving a request for a geo-location. According to this alternative example method, a request for a geo-location is received by first receiving a subject identifier (step 30). The term “subject identifier”, as used in this disclosure, means an identifier that can be used to identify a particular person, animal or asset that is the subject of a geo-location request. According to yet another alternative example method, the subject identifier is further correlated with a plurality of the geo-tracking devices (step 35). It should be appreciated that more than one geo-tracking device can be associated with a subject identifier.

According to one illustrative use case, the present method is used to control a plurality of geo-tracking devices that are affixed to a single individual (e.g. a child). It should be appreciated that where a single individual is associated with a plurality of geo-tracking devices, the geo-tracking devices can take on various forms. For example, a geo-tracking device can be integrated into various sundry items including, but not limited to a shoe, a pendant, a watch, a hat, a back-pack and a personal music device. Accordingly, the geo-tracking device will typically be integrated into such sundry items in a concealed manner. It should be further appreciated that each of these geo-tracking devices will typically be individually addressable by a tracking facility. Ergo, the individual addresses of each geo-tracking device must be associated with a single subject identifier.

FIG. 3 is a flow diagram that depicts one illustrative method for receiving a request for geo-location by means of a voice channel. According to this illustrative method, a request for geo-location is received by receiving a voice request from a user wherein the voice request comprises a subject identifier (step 40). The subject identifier is then entered into a system (step 45). The voice request, according to one variation of the present method, is received by a manual means wherein a human attendant answers a telephone call and receives a subject identifier from a human user that initiated the phone call. According to yet another variation of the present method, the voice request is received automatically. In one example variation of the present method, voice recognition is used to extract a subject identifier from a spoken phrase received from a human user that initiated the phone call. In yet another example variation of the present method, a touch-tone decoder is used to extract a subject identifier entered by human user that initiated the phone call wherein the human user enters the subject identifier on a touch-tone keypad.

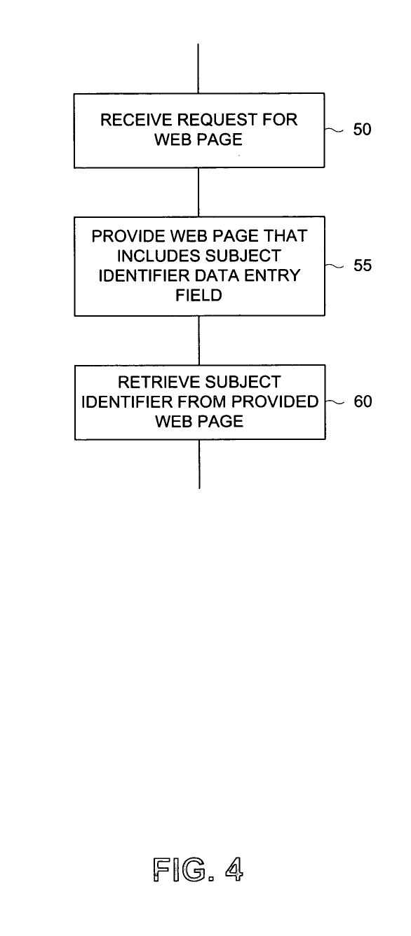

FIG. 4 is a flow diagram that depicts a web-based alternative method for receiving a geo-location request. According to this alternative method, a request for a geo-location is received by first receiving a request for a web page (step 15). In response to the request for web page, a web page is provided to a client device (step 55). According to this alternative method, the web page provided to the client device includes a subject identifier data entry field. Once a user enters a subject identifier in the data entry field, the present method provides for retrieving the subject identifier from the data entry field included in the provided web page (step 60). It should be appreciated that according to yet another variation of the present method, the web page provided in response to a request for web page further includes a password data entry field. Accordingly, another variation of the present method provides for validating a request for a geo-location by retrieving a password from the password data entry field and comparing the retrieved password for a pre-established password associated with the subject identifier.

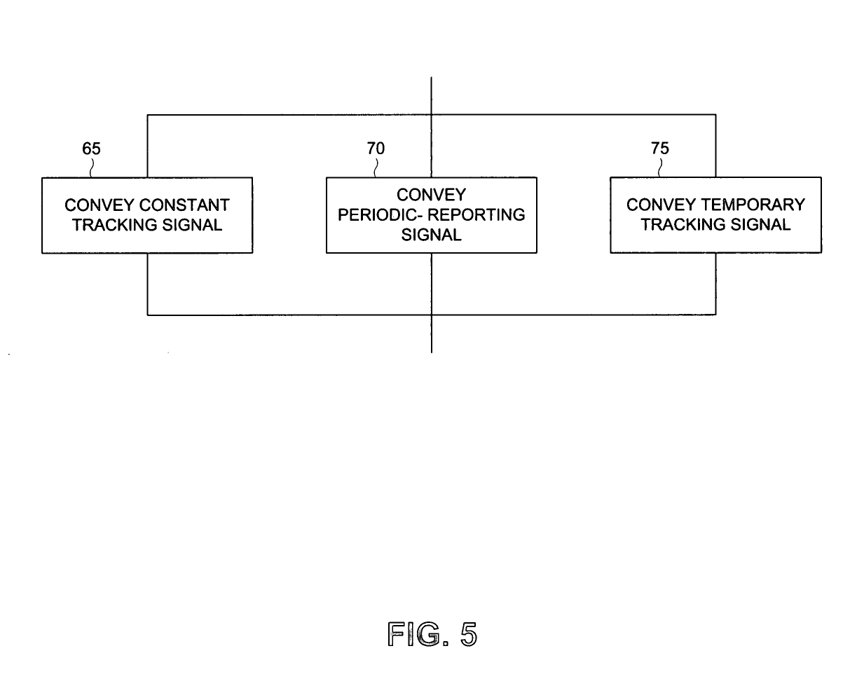

FIG. 5 is flow diagram that depicts alternative methods for conveying a wake-up message to a geo-tracking device. According to one variation of the present method, a constant-tracking wake-up signal is conveyed to a geo-tracking device. This variation of the present method is useful in a system where a geo-tracking device needs to provide a continuous stream of geo-position messages. For example, in a situation where a person, animal or asset is missing, is typically desirous to receive a geo-position message on a continuous basis. According to yet another variation of the present method, a periodic-reporting wake-up signal is conveyed to a geo-tracking device. This variation of the present method is useful in a situation where the geo-tracking device is associated with a person, an animal or an asset and a user is desirous of monitoring the movement of the person, animal or asset. According to yet another variation the present method, a temporary-tracking signal is conveyed to a geo-tracking device. This variation of the present method is useful where a user is desirous of determining the location of a person, animal or asset to a particular instant in time. Accordingly, a geo-tracking device, in response to a temporary-tracking signal, will typically provided one or more position messages and will typically provide only enough position messages to satisfy a short-duration geo-location request.

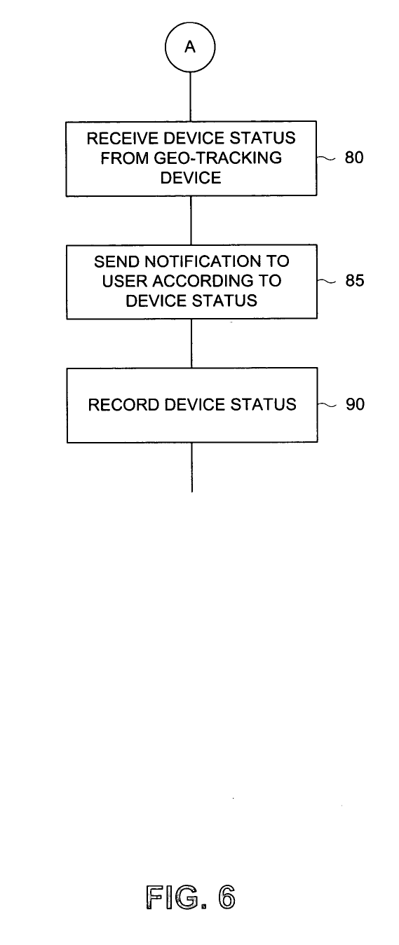

FIG. 6 is a flow diagram that depicts a variation the present method wherein a device status indicator is received from a geo-tracking device. According to one variation of the present method, controlling a geo-tracking device further comprises receiving a device status indicator from the geo-tracking device (step 80). In many applications, the status of the geo-tracking device must be determined in order to ensure high levels of system availability. For example, according to one variation the present method, the device status indicator comprises a battery-level indicator. According to yet another variation the present method, the device status indicator comprises a battery-low indicator. These are merely examples of various types of device status indicators they can be received from a geo-tracking device according to the present method. Accordingly, these examples are not intended to limit the scope of the claims appended hereto. It should be appreciated that a user desirous of maintaining high availability for geo-location capability for a particular person, animal or asset will likely be desirous of receiving a warning when a geo-tracking device is not operating in a nominal manner. Accordingly, a notification is sent to the user according to the received device status indicator (step 85). According to yet another variation the present method, a device status indicator received from a geo-tracking device is recorded (step 90). It should be appreciated that a system operator engaged in providing geo-location services may, in order to defray liability for injuries sustained by a user, use the recorded geo-tracking device status indicator as evidence that the user was warned that a geo-tracking device associated with the subject was not operating normally.

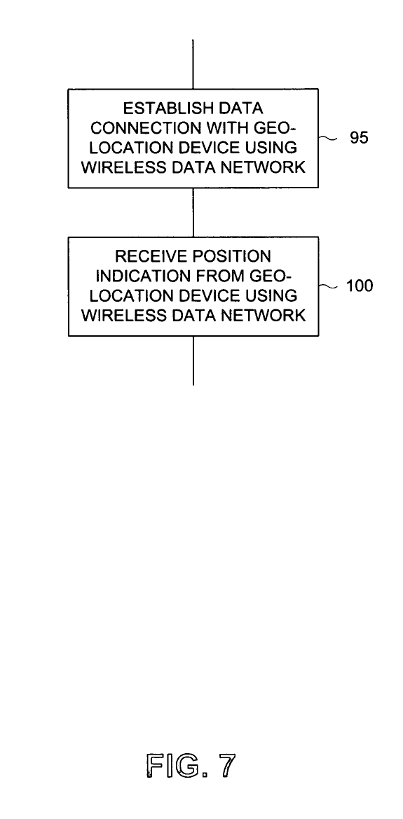

FIG. 7 is a flow diagram that depicts one example method for receiving a position report from a geo-tracking device. It should be appreciated that a geo-tracking device includes some form of cellular data interface (e.g. a cellular telephone circuit). According to one illustrative use case, a cellular data interface and a geo-position receiver included in a geo-tracking device are dormant (i.e. they are either not operating or operating in a low-power, standby mode) until a geo-location is required. In the present method, a unidirectional wake-up signal conveyed to the geo-tracking device causes the cellular data interface and the geo-position receiver to become operational. As such, the cellular data interface becomes communicatively associated with the tracking system by means of a data network. Typically, the data network comprises any combination of a wide area network and a wireless network (e.g. G3 cellular data network). As such, receiving a position report from a geo-tracking device comprises establishing a data connection with the geo-tracking device using a data network (step 95), which comprises any combination of a wide area network and a wireless network. The data connection is then used to receive a position indication from the geo-tracking device (step 100).

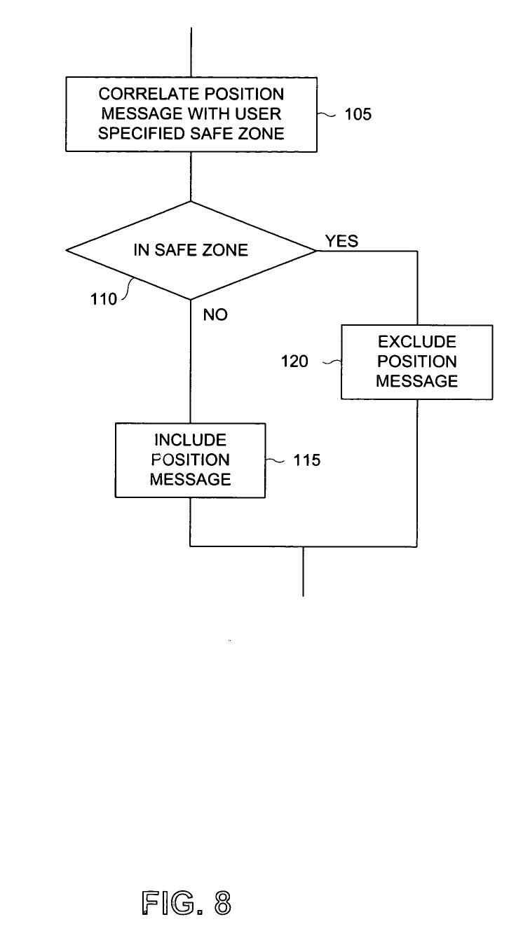

FIG. 8 is a flow diagram that depicts one example method for generating a position report. According to this example method, a position report is generated by correlating a position message received from a geo-tracking device with a user specified safe zone (step 105). It should be appreciated that, in certain circumstances, a person, an animal or an asset that is the subject of a geo-location request may not be in peril. In fact, a person, an animal or an asset can actually be in a zone of relative safety. More importantly, because one person, one animal or one asset can be associated with a plurality of geo-tracking devices, some of the geo-tracking device is ordinarily associated with the subject of the geo-location request may not be physically proximate to the subject. For example, consider a situation where a geo-tracking device is integrated into the child's shoe. In this particular instance, the child may be wearing a different pair of shoes and the shoe that includes the geo-tracking device could be in a closet. Accordingly, a geo-location message received from a geo-tracking device becomes pertinent only when the geo-tracking device is physically proximate to the subject. Accordingly, the present method provides for determining if a position message received from a geo-tracking device indicates that the geo-tracking device is within a safe zone (step 110). If the position message indicates that the geo-tracking device is within the safe zone, that position message is excluded from the position report (step 120). Otherwise, the position report is included in the position report (step 115).

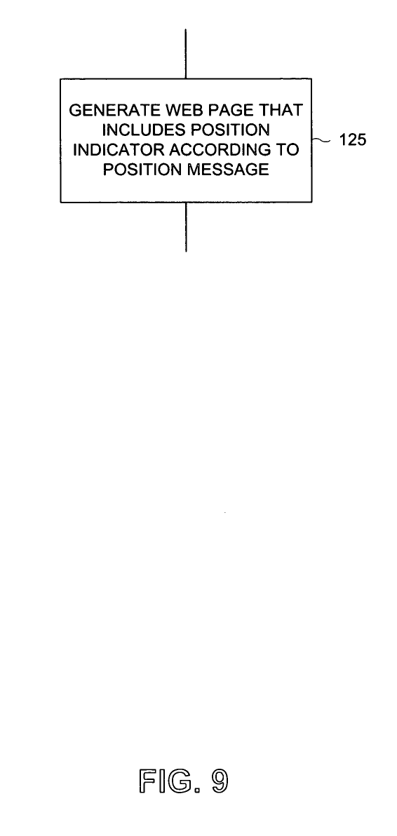

FIG. 9 is a flow diagram that depicts one example method for generating a web-page based position report. According to this example method, a position report is generated by receiving a position message from a geo-tracking device. A web page is then generated (step 125) according to the received position message. For example, when a user requests a geo-location for a subject, one or more geo-tracking devices associated with the subject (as determined by correlating one or more geo-tracking devices with a subject identifier) are interrogated in order to receive a geo-location position message from each of the geo-tracking devices. Typically, when a user makes such a request, the request is made by means of requesting a web page from a server. The server then provides a web page in response to the request. The web page provided in response to the request will include a data entry field that facilitates the receipt of a subject identifier. Accordingly, this web page will also include a submit hyper-link. The submit hyper-link will result in a request by the client device for the position report web page that includes a position indicator according to a position message received from one or more geo-tracking devices.

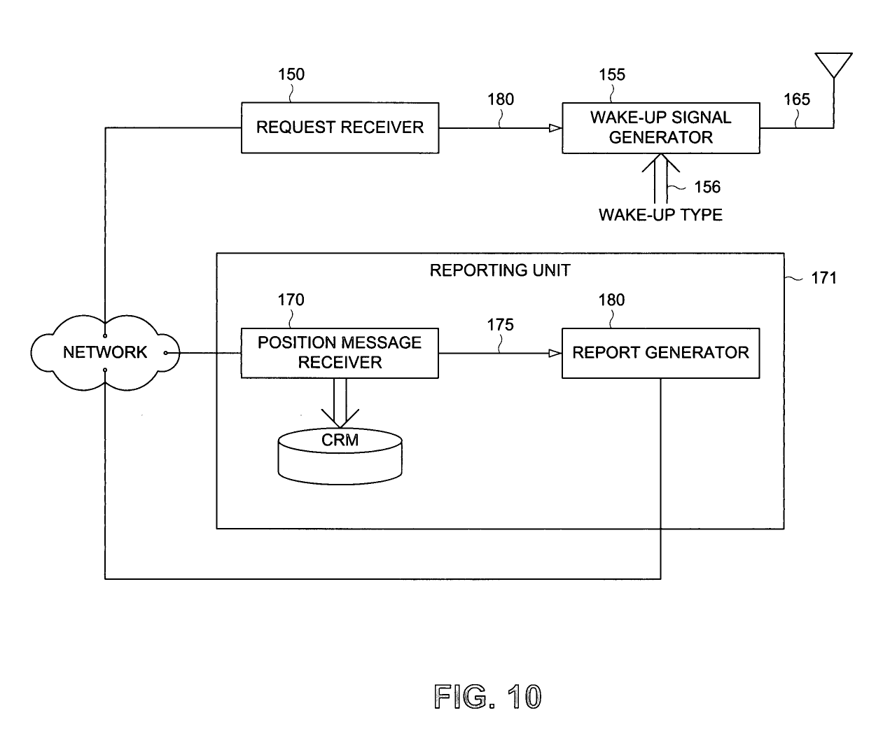

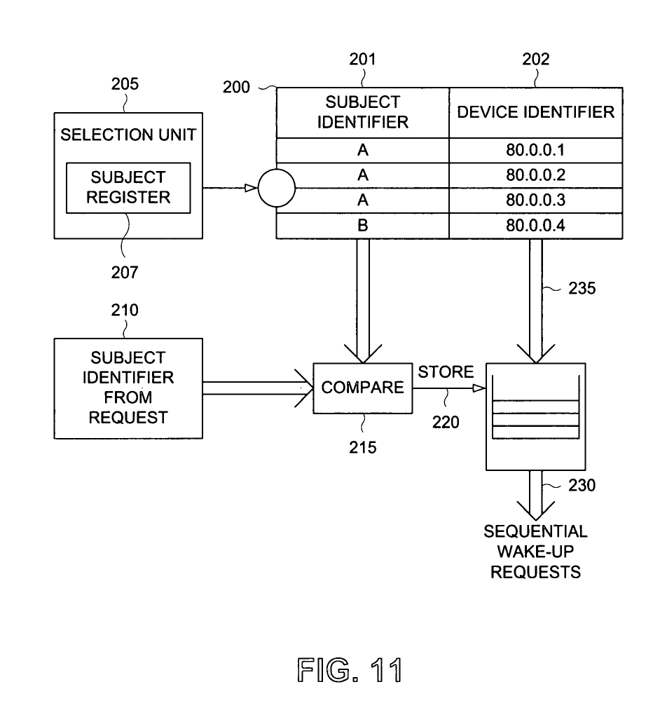

FIG. 10 is a block diagram that depicts one example embodiment of an apparatus for controlling a geo-tracking device. According to this example embodiment, an apparatus for controlling a geo-tracking device comprises a request receiver 150, a wake-up signal generator 155, a position message receiver and a report generator 180. According to one alternative embodiment, the position message receiver 107 and the report generator 180 are included a single device called the reporting unit 171.

In operation, the request receiver 150 generates a wake-up request 160 when it receives a request for a geo-location. According to this example embodiment, a wake-up signal generator 155 conveys a wake-up signal to a geo-tracking device according to the wake-up request 160 received from the request receiver 150. According to one alternative embodiment, the wake-up signal generator 155 receives a wake-up type indicator 156. The wake-up type indicator, according to this alternative embodiment, is used by the wake-up signal generator 155 to modify the type of wake-up signal it generates. For example, according to this alternative embodiment, the wake-up indicator comprises at least one of a constant-tracking indicator, a periodic-reporting indicator and a temporary-tracking indicator. As such, the wake-up signal generator 155 generates a wake-up signal according to the type of wake-up indicator 156 it receives. Accordingly, when the wake-up signal generator 155 receives a constant-tracking indicator, the wake up signal generator 155 generates a constant-tracking wake-up signal. It follows that the wake-up signal generator 155 will generate periodic-reporting wake-up signal when it receives a periodic-reporting indicator. It also follows that the wake-up signal generator 155 will generate a temporary-tracking signal when it receives a temporary-tracking indicator. The wake-up signal generator 155 than conveys 165 the wake-up signal to a geo-tracking device.

The position message receiver 170 of this example embodiment receives a position message from a geo-tracking device once the geo-tracking device wakes up in response to it a wake-up signal generated by the wake-up signal generator 155 and conveyed 165 thereto. A position message received by the position message receiver 170 is directed 175 to the report generator 180. The report generator 180, which includes a user interface, directs a report of geo-position to user by means of the user interface.

FIG. 11 is a block diagram that depicts one example embodiment of a request receiver. According to one alternative embodiment, the request receiver 150 comprises a subject register 207. The request receiver 150 typically receives a subject identifier 210. The subject identifier is stored in the subject register 207. According to yet another alternative embodiment, the request receiver further comprises a correlation table 200. The correlation table 200, according to one illustrative use case, is populated with one or more cross-references between a subject identifier 201 and the device identifier 202. It should be appreciated that the figure includes several examples of a subject identifier and device identifiers. One example of a subject identifier included in the figure comprises the letter “A”. One example of a device identifier included in the figure comprises a network address “80.0.0.1”. It should be appreciated that the examples of subject identifiers and device identifiers included in the figure are intended to illustrate the present apparatus and are not intended to limit the scope of the claims appended hereto.

According to one example embodiment, the subject register 207 is included a selection unit 205. The selection unit 205, which is included in one alternative embodiment of a request receiver, cycles through the correlation table 200 and compares the subject identifier 201 stored in each record included in the correlation table 200 to the value stored in the subject register 207. When a successful comparison occurs, a comparator 215 included in this example embodiment of a request receiver generates a store signal 220. The store signal 220 is used to store in a sequential memory the device identifier stored in device identifier field 202 of a record stored in the correlation table 200 wherein the subject identifier 201 field matches the value stored in the subject register 207. The sequential memory, according to one alternative embodiment, comprises a first-in-first-out (FIFO) memory. Emerging from the FIFO memory is a sequential stream of wake-up requests 230. Each wake-up request includes the device identifier of a geo-tracking device associated with a particular subject. It should be appreciated that the subject, in this case, is the subject of a geo-location request.

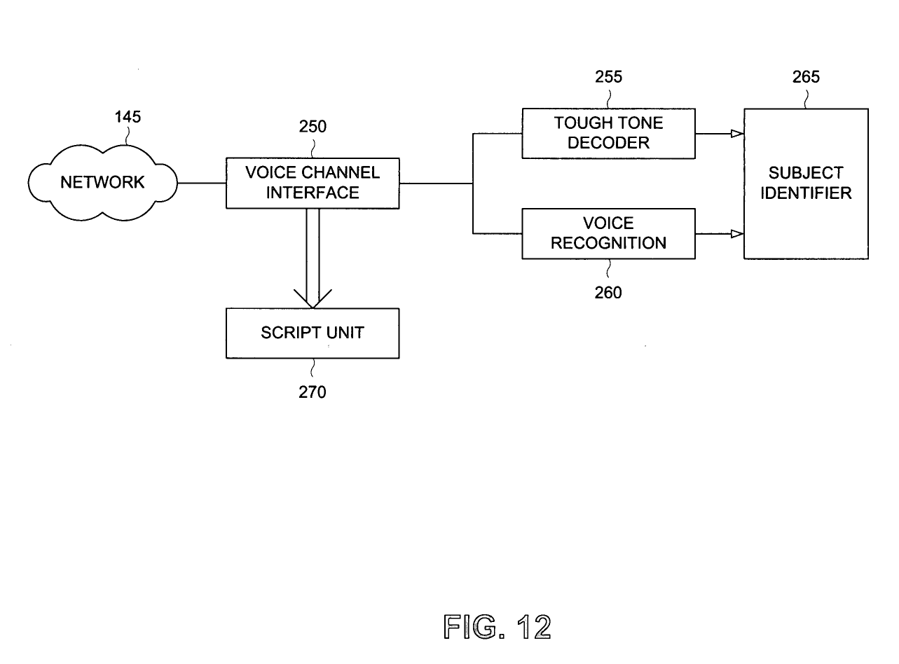

FIG. 12 is a block diagram that depicts one alternative embodiment of a request receiver capable of receiving a request over a voice channel. According to this alternative embodiment, the request receiver comprises a voice channel interface 250, a script unit 270 and at least one of detection decoder 255 and a voice recognition unit 260. This embodiment further includes the subject register 265. In operation, the voice channel interface 250 interfaces with a voice circuit. One example of a voice circuit is a digital telephony network 145. A T1 digital telephony interface is one example of a digital telephony network is presented herein to illustrate the present embodiment is not intended to limit the scope of the claims appended hereto. In another alternative embodiment, the voice channel interface 250 interfaces with an analog telephone line.

As this example embodiment of a request receiver operates, the voice channel interface 250 answers an incoming telephone call from a user desirous of obtaining a geo-location for the person, an animal or an asset. Accordingly, once the voice channel interface 250 answers the incoming telephone call, the script unit 270 provides audible instructions to user. Such audible instructions, according to one embodiment, including, but not limited to a request that a user enter a subject identifier and a request that a user enter a password.

In one alternative embodiment that includes a touchtone decoder 255, the touchtone decoder 255 receives a subject identifier in the form of touchtone signals generated as result of a user depressing one or more keys on a touchtone keypad. The received subject identifier is then stored in the subject register 265. In yet another alternative embodiment, the touchtone decoder 255 further receives a password in the form of touchtone signals generated as result of a user depressing one or more keys on a touchtone keypad. The password received by the touchtone decoder 255 and then be used to validate the geo-location request.

According to yet another alternative embodiment that includes a voice recognition circuit 260, the voice recognition circuit 260 receives a subject identifier in the form of a spoken phrase spoken by a user that initiated the telephone call. The voice recognition circuit 260 converts the spoken phrase into a subject identifier that is then stored in the subject register 265. In yet another alternative embodiment, the voice recognition circuit 260 further receives a password in the form of the spoken phrase. The voice recognition circuit 260 converts the spoken phrase into a digital password which can be used to validate a geo-location request.

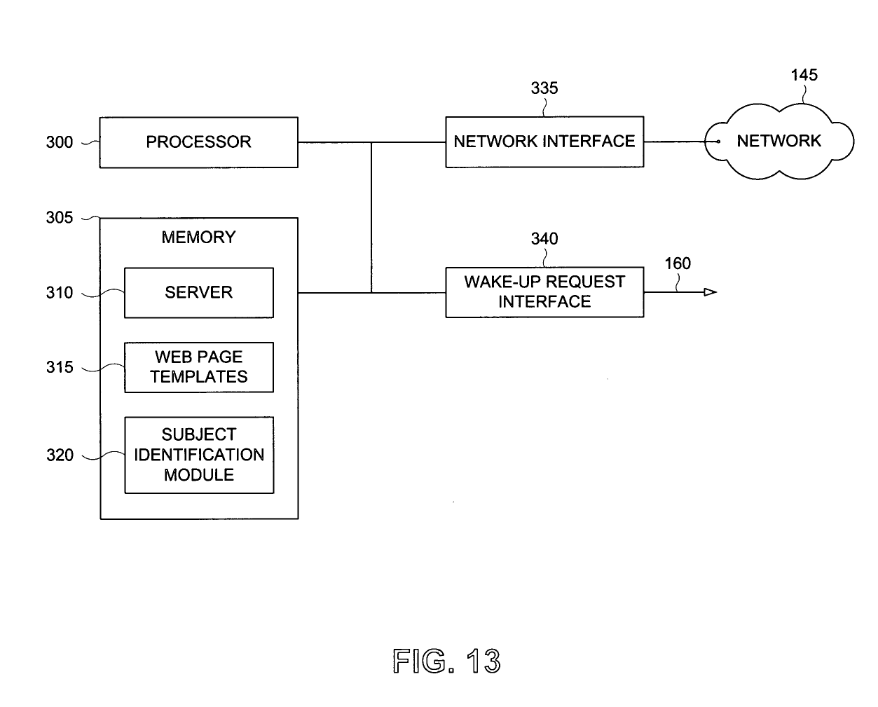

FIG. 13 is a block that depicts one alternative embodiment of a request receiver capable of receiving a geo-location request by means of a web page. According to this example embodiment, the request receiver comprises a processor 300, the network interface 335, a wake-up request interface 340 and a memory 305. The network interface 335 enables the processor 300 to communicate with a data network 145.

This example embodiment of a request receiver further includes various functional modules each of which comprises an instruction sequence that can be executed by the processor. The instruction sequence that implements a functional module, according to one alternative embodiment, is stored in the memory 305. The reader is advised that the term “minimally causes the processor” and variants thereof is intended to serve as an open-ended enumeration of functions performed by the processor as it executes a particular functional module (i.e. instruction sequence). As such, an embodiment where a particular functional module causes a processor to perform functions in addition to those defined in the appended claims is to be included in the scope of the claims appended hereto.

The functional processes (and their corresponding instruction sequences) herein described enable receipt of a geo-location request according to the teachings of the present method. According to one embodiment, these functional processes are imparted onto computer readable medium. Examples of such media include, but are not limited to, random access memory, read-only memory (ROM), Compact Disk (CD ROM), floppy disks, and magnetic tape. This computer readable medium, which alone or in combination can constitute a stand-alone product, can be used to convert a general-purpose computing platform into a device capable of receiving a geo-location request according to the techniques and teachings presented herein. Accordingly, the claims appended hereto are to include such computer readable medium imparted with such instruction sequences that enable execution of the present method and all of the teachings afore described.

Included in this embodiment of the request receiver are a server module 310 and a subject identification module 320. Both the server module 310 and the subject identification module 320 are stored in the memory 305. Also stored in the memory 305 are one or more web page templates 315. According to this example embodiment, the server module, when executed by the processor 300, minimally causes the processor 300 to receive a request for a web page by means of the network interface 335. Typically, the network interface 335 interfaces to a data network 145. In operation, a client device, which is also attached a data network 145, dispatches a request for a web page to the request receiver. Accordingly, the server module 310, when executed by the processor 300, further minimally causes the processor 300 to retrieve a web page 315 from the memory 305 and convey the web page to the network interface 335. According to this example embodiment, the web page 315 includes a data entry field which a user can use to enter a subject identifier. According to yet another example embodiment, the web page 315 further includes a data entry fields which a user can use to enter a password. A password entered by user, according to yet another alternative embodiment, is used to validate a geo-location request.

The subject identification module 320 of this example embodiment, when executed by the processor 300, minimally causes the processor to extract a subject identifier from the web page data entry field included in the web page provided to the client by means of the network interface 335. According to yet another alternative embodiment, the subject identification module 320, when executed by the processor 300, further minimally causes the processor 300 to extract a password from the password data entry field included in the web page directed to a client device by means of the network interface 335. Once a subject identifier is retrieve from the data entry field, with this example embodiment of a subject identification module 320 further minimally causes the processor to convey to the wake-up request interface 340. The wake-up request interface 340 conveys the wake-up request 160 to the wake-up signal generator 155. It should be appreciated that the wake-up request directed to the wake-up signal generator 155 includes the subject identifier. Accordingly, the wake-up signal generator 155 conveys a wake-up signal 165 has directed to a particular geo-tracking device according to the subject identifier.

It should be appreciated that one alternative embodiment of a request receiver further includes a correlation module that is also stored in the memory 305. The correlation module, when executed by the processor 300, minimally causes the processor to correlate a subject identifier with a plurality of geo-tracking devices. This alternative environment, the correlation module, when executed by the processor 300, further minimally causes the processor 300 to direct the plurality of wake-up requests to the wake-up request interface 340. It should be further appreciated that each wake-up request so directed to the wake-up request interface 340 is directed to a particular geo-tracking device will according to a device identifier. It should also further be appreciated that the correlation, accomplished by the processor 300 as it executes correlation module, results in cross-referencing a single subject identifier to a plurality of device identifiers commensurate with the teachings of the present method.

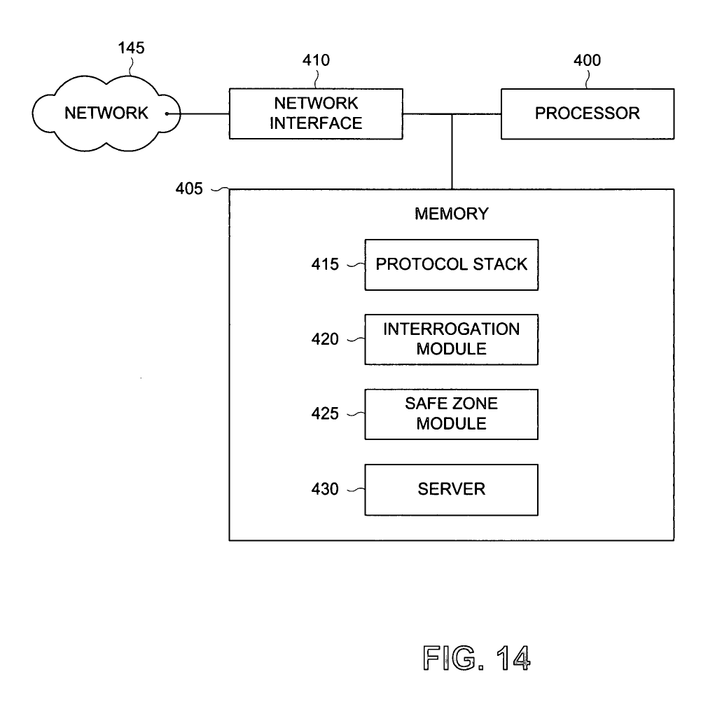

FIG. 14 is a block that depicts one alternative embodiment of a position message receiver capable of receiving a geo-location position message from a geo-tracking device. According to this example embodiment, the position message receiver comprises a processor 400, a network interface 410 and a memory 405. The network interface 410 enables the processor 400 to communicate with a data network 145.

This example embodiment of a request receiver further includes various functional modules each of which comprises an instruction sequence that can be executed by the processor. The instruction sequence that implements a functional module, according to one alternative embodiment, is stored in the memory 305. The reader is advised that the term “minimally causes the processor” and variants thereof is intended to serve as an open-ended enumeration of functions performed by the processor as it executes a particular functional module (i.e. instruction sequence). As such, an embodiment where a particular functional module causes a processor to perform functions in addition to those defined in the appended claims is to be included in the scope of the claims appended hereto. Included in this embodiment of the position message receiver are a protocol stack 415 and an interrogation module 420.

The functional processes (and their corresponding instruction sequences) herein described enable receipt of a geo-location position message according to the teachings of the present method. According to one embodiment, these functional processes are imparted onto computer readable medium. Examples of such medium include, but are not limited to, random access memory, read-only memory (ROM), Compact Disk (CD ROM), floppy disks, and magnetic tape. This computer readable medium, which alone or in combination can constitute a stand-alone product, can be used to convert a general-purpose computing platform into a device capable of receiving a geo-location position message according to the techniques and teachings presented herein. Accordingly, the claims appended hereto are to include such computer readable medium imparted with such instruction sequences that enable execution of the present method and all of the teachings afore described.

FIG. 14 also illustrates alternative embodiments of a report generator. According to one alternative embodiment, a report generator comprises a processor 400, a network interface 410 and a memory 405. Stored in the memory is a safe zone module 425 that is included in one alternative embodiment of a report generator. Included in the memory of yet another embodiment of a report generator is a report module 431.

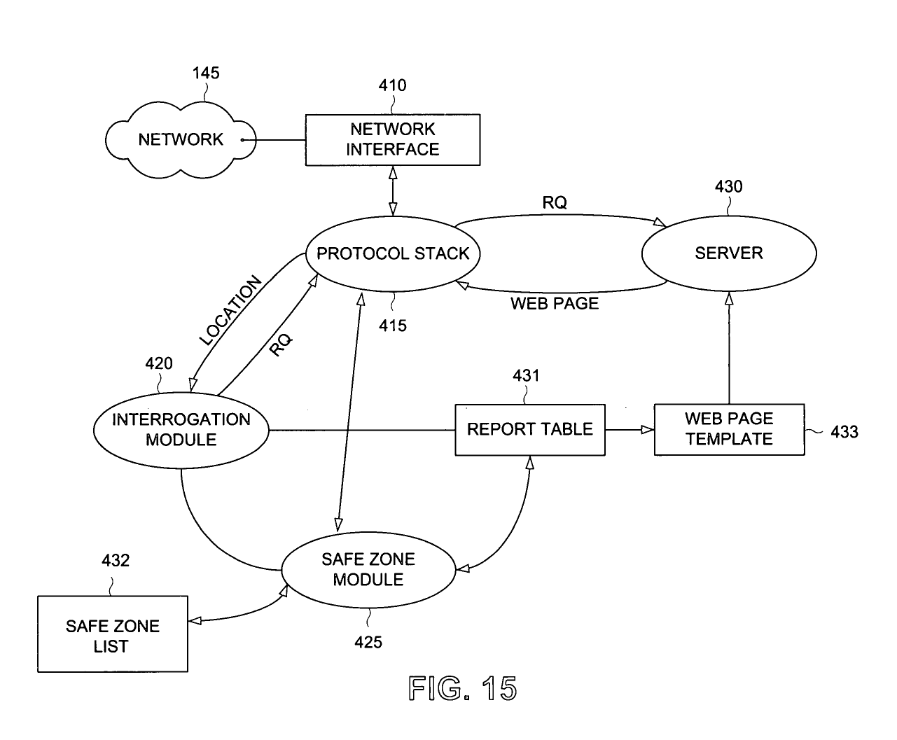

FIG. 15 is a data flow diagram that depicts the internal operation of several alternative embodiments of a position message receiver. When executed by the processor 400, one example embodiment of a protocol stack 415 minimally causes the processor 400 to control the network interface 410, thereby enabling data communications with a network 145. Using the protocol stack 415, the processor is minimally caused to establish a connection with a geo—location device using the network interface 410. As a processor continues to operate, it executes the interrogation module 420. The interrogation module 420, when executed by the processor, minimally causes the processor 400 to receive a position indicator from a geo-location device using the connection established by the processor when it executes the protocol stack 415. In operation, the interrogation module 420, when executed by the processor 400, minimally causes the processor to ensure request to a deal-location device using the network interface 410 (i.e. by means of the protocol stack 415). In response, a geo—location device will provide a location which is received by way of a connection established by means of the protocol stack 415. The interrogation module 420 provides a location indicator, which is stored in a report table 431 in the memory 405.

FIG. 15 also illustrates the internal operation of several example embodiments of a report generator. According to one example embodiment, the processor 400 executes a safe zone module 425. According to this example embodiment, the safe zone module 425 minimally causes the processor 400 to receiving a safe zone specification from a client device. Typically, the client device will use a data network 145 to establish a communications connection with the safe zone module 425. The processor 400, as it executes the safe zone module 425, engages in a communications connection by executing the protocol stack 415. As the processor 400 continues to executes a safe zone module 425, the safe zone module 425 minimally causes the processor to store a safe zone specification in a safe zone list 432, which is stored in the memory 405. On a periodic basis, the safe zone module 425 further minimally causes the processor to examine a position indicator stored in the report table 431. When the processor discovers a position indicator stored in the report table 431, it will exclude a position indicator when the position indicator lies within a user specified safe zone according to a safe zone specification stored in the safe zone list 432.

According to one alternative example embodiment, the processor 400 executes the protocol stack 415 in order to establish a connection with a client using the network interface 410. Typically, the connection is establish when a client uses a data network 145 in order to request a web page from a server module 430 included in one example embodiment of a report generator. The server module 430, when executed by the processor 400, further minimally causes the processor to generate a web page. According to one alternative embodiment, the server module 430 causes the processor to generate a web page according to a webpage template 433. The web page template 433, according to one alternative embodiment, includes a definition for a position indicator. The position indicator is modified according to a position indicator stored in the report table 431. Once the server generates the web page, it provides web page to a client by means of the network interface 410. Accordingly, a connection to the client is maintained by the processor 400 as it continues to executes the protocol stack module 415.

While this disclosure has described several alternative methods and exemplary embodiments, it is contemplated that alternatives, modifications, permutations, and equivalents thereof will become apparent to those skilled in the art upon a reading of the specification and study of the drawings. It is therefore intended that the true spirit and scope of the appended claims include all such alternatives, modifications, permutations, and equivalents.

What is claimed is:

1. A method for controlling a geo-tracking device comprising:
receiving a request for a geo-location;
conveying a wake-up signal to a geo-tracking device according to the request for a geo-location;
receiving from the geo-tracking device one or more position messages;
generating a position report according the position message; and
conveying the position report to a user.

2. The method of claim 1 wherein receiving a request for geo-location comprises receiving a subject identifier.

3. The method of claim 2 further comprising correlating the subject identifier to a plurality of geo-tracking devices.

4. The method of claim 1 wherein receiving a request for geo-location comprises:
receiving a voice request from a user that includes a subject identifier; and
entering the subject identifier into a geo-location system.

5. The method of claim 1 wherein receiving a request for geo-location comprises:
receiving a request for a web-page; and
providing in response to the request for a web page, a web page that includes a subject identifier data entry field; and
retrieving a subject identifier from the provided web page.

6. The method of claim 1 wherein conveying a wake-up message comprises at least one of conveying a constant tracking signal to a geo-tracking device, a conveying a periodic-reporting signal to a geo-tracking device and conveying a temporary tracking signal to a geo-tracking device.

7. The method of claim 1 further comprising:
receiving a device status indication from the geo-tracking device; and
sending a notification to the user according to the device status indication.

8. The method of claim 7 further comprising recording the device status indication.

9. The method of claim 1 wherein receiving a position report comprises:
establishing a data connection with the geo-location device using a wireless data network; and
receiving a position indicator from the geo-location device using the data connection.

10. The method of claim 1 wherein generating a position report comprises:
correlating a position message with a user specified safe zone; and
excluding a position message when the position message is within the user specified safe zone;
including a position message when the position message is not within the user specified safe zone.

11. The method of claim 1 wherein generating a position report comprises generating a web page description that includes a position indicator according to a position message.

12. An apparatus for controlling a geo-tracking device comprising:
request receiver capable of generating a wake-up request when a request for a geo-location is received;
wake-up signal generator capable of wirelessly conveying a wake-up signal to a geo-tracking device according to the wake-up request;
position message receiver capable of receiving a position message from the geo-tracking device; and
report generator capable of generating a position report according to a position message received by the position message receiver wherein the report generator further comprises a user interface capable of conveying the position report to a user.

13. The apparatus of claim 12 wherein the request receiver comprises a subject register.

14. The apparatus of claim 13 further comprising correlation table capable of cross-referencing a subject identifier to a plurality of device identifiers and generating a plurality of wake-up requests.

15. The apparatus of claim 12 wherein the request receiver comprises:
voice channel interface capable of interfacing with a voice circuit;
script unit capable of answering a voice connection established by the voice channel interface and conveying an audible script to the voice connection; and
at least one of a touch-tone decoder and a voice recognition unit capable of extracting a subject identifier from a voice connection.

16. The apparatus of claim 12 wherein the request receiver comprises:
processor capable of executing an instruction sequence;
network interface capable of enabling communication by the processor to a data network;
wake-up request interface capable of dispatching a wake-up request to a wake-up signal generator;
memory capable of storing an instruction sequence; and
one or more instruction sequences stored in the memory including:
server module that, when executed by the processor, minimally causes the processor to direct a web page to the network interface in response to a request received by way of the network interface; and
subject identification module that, when executed by the processor, minimally causes the processor to extract a subject identifier from a web page data entry field and convey the extracted subject identifier to the wake-up request interface.

17. The apparatus of claim 12 wherein the wake-up signal generator is capable of generating at least one of a constant tracking signal, a periodic-reporting signal and a temporary tracking signal according to a wake-up type indicator.

18. The apparatus of claim 12 wherein the position message receiver is further capable of receiving a device status indicator from a geo-tracking device.

19. The apparatus of claim 18 further comprising a computer readable medium capable of recording a device status indicator.

20. The apparatus of claim 12 wherein the position message receiver comprises:
processor capable of executing an instruction sequence;
network interface capable of enabling communication by the processor to a data network;
memory capable of storing an instruction sequence; and
one or more instruction sequences stored in the memory including:
protocol stack that, when executed by the processor, minimally causes the processor to establish a connection with a geo-location device using the network interface; and
interrogation module that, when executed by the processor, minimally causes the processor to receive a position indicator from a geo-location using a connection established by the processor when it executes the protocol stack.

21. The apparatus of claim 12 wherein the report generator comprises:
processor capable of executing an instruction sequence;
network interface capable of enabling communication by the processor to a data network;
memory capable of storing an instruction sequence; and
one or more instruction sequences stored in the memory including:
protocol stack that, when executed by the processor, minimally causes the processor to establish a connection with a client using the network interface; and
safe zone module that, when executed by the processor, minimally causes the processor to receive a safe zone specification from a user by way of a connection established with a client device by the processor when it executes the protocol stack and further minimally causes the processor to exclude a position report stored in the memory when the position report lies within the user specified safe zone.

22. The apparatus of claim 12 wherein the report generator comprises:
processor capable of executing an instruction sequence;
network interface capable of enabling communication by the processor to a data network;
memory capable of storing an instruction sequence; and
one or more instruction sequences stored in the memory including:
protocol stack that, when executed by the processor, minimally causes the processor to establish a connection with a client using the network interface; and
server module that, when executed by the processor, minimally causes the processor to generate a web page that includes a position indicator according to a position message stored in the memory and further minimally causes the processor to direct the web page to a connection established by the processor when it executes the protocol stack.
